(19) United States
(12) Patent Application Publication
(10) Pub. No.: US 2004/0215941 A1
(43) Pub. Date: Oct. 28, 2004

(54) Method and system to handle register window fill and spill

(75) Inventors: Chandra M.R. Thimmannagari, Fremont, CA (US); Sorin Iacobovici, San Jose, CA (US); Rabin Sugumar, Sunnyvale, CA (US)

Correspondence Address: ZAGORIN O'BRIEN & GRAHAM, L.L.P., 7600B N. CAPITAL OF TEXAS HWY., SUITE 350, AUSTIN, TX, 78731, US

(73) Assignee: Sun Microsystems, Inc.

(21) Appl. No.: 10/422,174

(22) Filed: Apr. 24, 2003

(51) Int. Cl. G06F 9/00

(52) U.S. Cl. 712/228

(57) ABSTRACT

A technique for handling window-fill and/or window-spill operations that improves the performance of a processor over traditional techniques is presented. The window-fill and window-spill operations can be handled in hardware using helper instructions (helpers) prior to the generation of a trap (exception). Fetched instructions are examined prior to forwarding for execution to detect a potential register window boundary condition necessitating, for example, a window-fill or window-spill operation. Vectors are generated for a helper storage within the processor to retrieve helpers for resolving the condition. The helpers are forwarded for execution prior to the instruction that would cause the condition. In some embodiments, to improve the processing, individual helper storages are implemented for every condition. The use of helpers to resolve a register window boundary condition eliminates the generation of a trap and the use of trap handler code.

### CROSS-REFERENCE TO RELATED APPLICATION(S)

The present application is related to U.S. patent application No. ______ {Attorney Docket No. 004-8634}, entitled “Helper Logic for Complex Instructions” filed on Mar. 31, 2003 having Chandra M. R. Thimmannagari, Sorin Iacobovici and Rabin Sugumar as inventors, U.S. patent application Ser. No. 10/165,256 {Attorney Docket No. 004-7350}, entitled “Register Window Fill Technique for Retirement Window Having Entry Size Less Than Amount of Fill Instructions” filed on Jun. 7, 2002 having Chandra M. R. Thimmannagari, Rabin Sugumar, Sorin Iacobovici, and Robert Nuckolls as inventors, and U.S. patent application Ser. No. 10/165,268 {Attorney Docket No. 004-7351}, entitled “Register Window Spill Technique for Retirement Window Having Entry Size Less Than Amount of Spill Instructions” filed on Jun. 7, 2002 having Chandra M. R. Thimmannagari, Rabin Sugumar, Sorin Iacobovici, and Robert Nuckolls as inventors. All of these applications are assigned Sun Microsystems, Inc., the assignee of the present invention, and are hereby incorporated by reference.

### BACKGROUND

1. Field of the Invention

The present application relates to processor architecture, more particularly to the handling of register window fill and spill conditions.

2. Description of the Related Art

Generally, instructions are executed in their entirety in one or more processors to maintain the speed and efficiency of execution. As instructions become more complex (e.g., atomic, integer-multiply, integer-divide, move on integer registers, graphics, floating point calculations or the like) the complexity of the processor architecture also increases accordingly. Complex processor architectures require extensive silicon space in the semiconductor integrated circuits. To limit the size of the semiconductor integrated circuits, typically, the functionality the processor is compromised by reducing the number of on-chip peripherals or by performing certain complex operations in the software to reduce the amount of complex logic in the semiconductor integrated circuits.

A processor uses registers arranged in a register window to store operands. Multiple register windows can be available and can be arranged as a ring—giving software the illusion of an infinite number of register windows. Software can use a “save” type instruction to move to a new window and a “restore” type instruction to return to a previous window. Register windows are commonly used for procedure calls so that each procedure has its own private set of local registers for its own use. A register window boundary condition such as a register window overflow or underflow occurs when an attempt to move to an invalid register window is made. An invalid register window is, for example, one that contains either no valid data when attempting a restore (underflow) or valid data when attempting a save (overflow). A trap (exception) is taken by the system and a trap handler code is fetched to resolve the register window boundary condition. The trap handler code either retrieves register window(s) from the stack (window fill operation) or sends register window(s) to the stack (window spill operation).

The fetching of trap handler code consumes processor resources and increases the execution intervals on the processor. The trap handler code may include complex instructions which can further increase the complexity of the processor and affect the processor efficiency. A method and a system are needed to handle window-fill/-spill operations without increasing the logic complexity and affecting the efficiency of the processor.

### SUMMARY

Accordingly, the present invention describes a technique for handling window-fill and/or window-spill operations that improves the performance of a processor over traditional techniques. The window-fill and window-spill operations can be handled in hardware using helper instructions (helpers) prior to the generation of a trap (exception). Fetched instructions are examined prior to forwarding for execution to detect a potential register window boundary condition necessitating, for example, a window-fill or window-spill operation. Vectors are generated for a helper storage within the processor to retrieve helpers for resolving the condition. The helpers are forwarded for execution prior to the instruction that would cause the condition. In some variations, the helper storage includes helpers to address window-fill and/or window spill operations. In some embodiments, to improve the processing, individual helper storages are implemented for every condition. The use of helpers to resolve a register window boundary condition eliminates the generation of a trap (exception) and the use of trap handler code.

In one embodiment, a processor detects a fetched instruction that will, when executed, cause a register window boundary condition and avoids the register window boundary condition by forwarding for execution a set of helper instructions prior to forwarding for execution the fetched instruction.

In another embodiment, a processor detects a fetched instruction that will, when executed, cause a trap condition and avoids the trap condition by forwarding a set of helper instructions prior to forwarding the fetched instruction.

In another embodiment, a method includes fetching a plurality of instructions, detecting that one of the fetched instructions will, when executed, result in a register window boundary condition, and forwarding a set of helper instructions prior to forwarding the detected instruction to avoid the register window boundary condition when the one of the detected of instruction is executed.

The foregoing is a summary and thus contains, by necessity, simplifications, generalizations and omissions of detail. Consequently, those skilled in the art will appreciate that the foregoing summary is illustrative only and that it is not intended to be in any way limiting of the invention. Other aspects, inventive features, and advantages of the present invention, as defined solely by the claims, may be apparent from the detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 illustrates an exemplary architecture of a processor according to an embodiment of the present invention.

FIG. 2 illustrates an exemplary register window boundary handler system using helpers in a processor according to an embodiment of the present invention.

FIG. 3A illustrates an implementation of a register window boundary handler system using helpers for a given condition according to an embodiment of the present invention.

FIG. 3B illustrates an exemplary helper storage according to an embodiment of the present invention.

FIG. 4 illustrates a flow diagram of handling a register window boundary condition according to an embodiment of the present invention.

The use of the same reference symbols in different drawings indicates similar or identical items.

### DESCRIPTION OF THE PREFERRED EMBODIMENT(S)

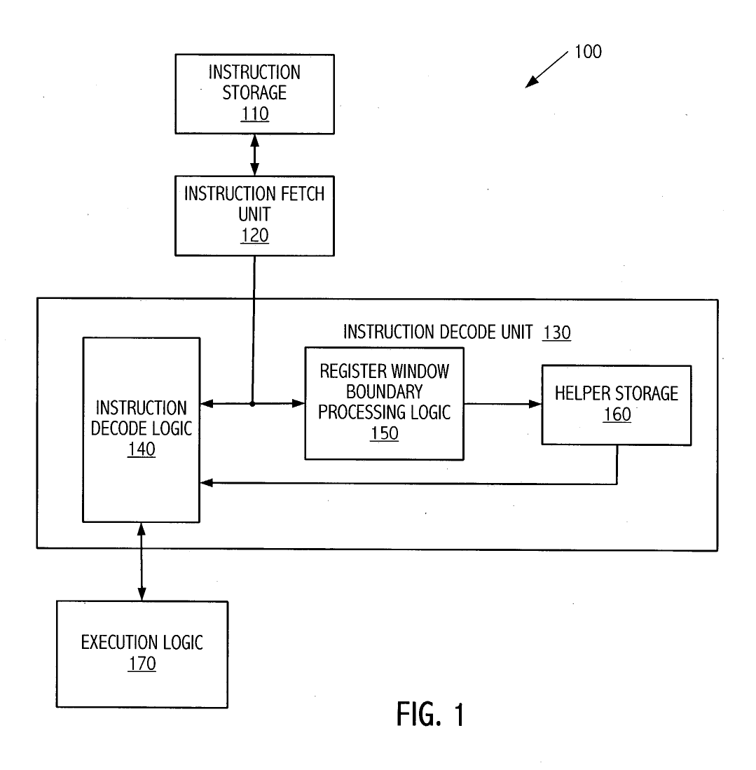

FIG. 1 illustrates an exemplary architecture of a processor according to an embodiment of the present invention. A processor (“processor”) 100 includes an instruction storage 110. Instruction storage can be any storage (e.g., cache, main memory, peripheral storage or the like) to store the executable instructions. An instruction fetch unit (IFU) 120 is coupled to instruction storage 110. IFU 120 is configured to fetch instructions from instruction storage 110. IFU 120 can fetch multiple instructions in one clock cycle (e.g., three, four, five or the like) according to the architectural configuration of processor 100.

An instruction decode unit (IDU) 130 is coupled to instruction fetch unit 120. IDU 130 decodes instructions fetched by IFU 120. IDU 130 includes an instruction decode logic 140 configured to decode instructions. Instruction decode logic 140 is coupled to a register window boundary processing logic 150. Register window boundary processing logic 150 is coupled to a helper storage 160. Register window boundary processing logic 150 is configured to detect if a fetched instruction (an offending instruction) will result in a register window boundary condition upon execution. A register window boundary condition can be, for example, a register window overflow or underflow condition necessitating a register window spill or fill operation, respectively. Register window boundary processing logic 150 is also configured to determine if the condition is to be handled with helpers, for example, by consulting a register. Register window boundary processing logic 150 is configured to retrieve a set of helper instructions (“helpers”) from a helper storage 160 if the condition is to be handled with helpers. The detection of a register boundary condition can be made using various methods known in the art (e.g., decoding the opcode or the like, consulting control registers and window management registers). If the register window boundary condition is not to be handled with helpers, the instructions are forwarded for execution. Executing the offending instruction will cause a trap (exception) and a software trap handler is called.

The set of helper instructions are configured to resolve the register window boundary condition such that upon execution, the offending instruction does not cause a trap. The helpers reduce the amount of time and overhead to handle a register window boundary condition in software by handling the register window boundary condition in hardware. IDU 130 forwards the group of instructions and the set of helpers to an execution logic 170. The set of helpers are forwarded prior to the offending instruction. Execution logic 170 represents various individual units in processor 100 needed to execute instructions. While for purposes of illustration, one execution logic is shown, one skilled in the art will appreciate that execution logic 170 can include various instruction execution related units (e.g., instruction rename unit, commit unit, execution unit, cache, memory and the like).

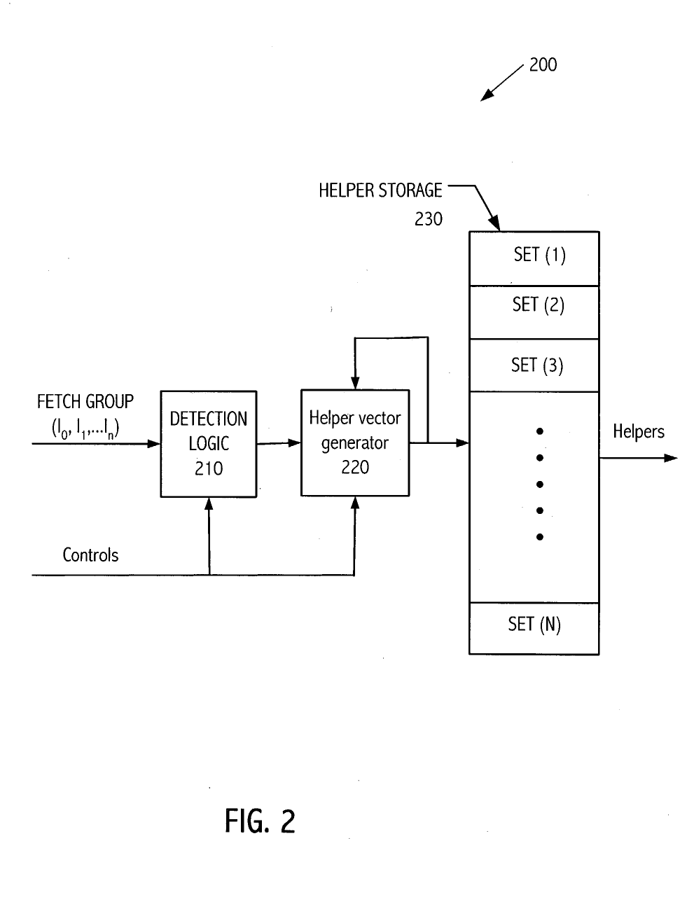

FIG. 2 illustrates an example of a register window boundary handler system 200 using helpers according to an embodiment of the present invention. System 200 includes a detection logic 210 configured to detect whether any instructions in a fetch group (I₀, I₁, . . . Iₙ) when executed, will result in a register window boundary condition. When a register window boundary condition (e.g., a register window overflow necessitating a window spill, a register window underflow necessitating a window fill, or the like) is encountered during the execution of an instruction, a trap (exception) occurs and a software trap handler is called. For example, if the processor supports ‘n’ circular register windows, window (1)-(n), and during code execution in window (n−1) the processor executes an instruction (e.g., SAVE (SPARC v9) or the like) requiring the processor to save the contents of current register window plus two (e.g., window(1)) so that a new register window (e.g., window(n)) can be used by the code then the processor enters into a window-spill trap because the processor has run out of valid register windows and moving to the next window i.e., window(n), might corrupt the data saved for some previous routine in window (1). The window-spill trap saves the contents of the current window register plus two (i.e. window (1)) on to a stack to release register window(n) for the use of the current code execution. Similarly, when a processor executes an instruction (e.g. RESTORE, RETURN (SPARC v9) or the like) requiring the processor to retrieve the contents of the previous register window from the stack then the processor enters into a window-fill trap. The concepts of window-fill and window-spill are known in the art.

Typically, during a trap, the processor fetches the trap handler code from external instruction storage. According to an embodiment of the present invention, after detecting a potential register window boundary condition (e.g., a register window underflow necessitating a window-fill operation, a register window overflow necessitating a window-spill operation, or the like) by examining the instructions in a fetch group, the processor can determine whether to handle the condition with a trap and trap handler code from the external instruction storage or to prevent a trap by handling the condition by retrieving and executing helpers from the hardware. Various helpers can be configured in the hardware of the processor according to the complexity of the processor logic to handle the register window boundary condition within the processor without resorting to a trap and software trap handler code in the external instruction storage. By providing helpers in the hardware for register window boundary conditions, the performance of the processor can be improved. Various means can be employed for the processor to determine for a given register window boundary condition whether to cause a trap and fetch trap handler code from external instruction storage or to retrieve helpers defined in the hardware and avoid a trap and software fetch. For example, special purpose registers can be configured within the processor to program a software trap or hardware helper handling. These special purpose registers can be programmed by the software (operating system or the like) executing in the processor or can be hardwired. For example, under a given register window boundary condition (e.g., window-spill), these special purpose registers can be programmed for the processor to retrieve helpers from the hardware. One skilled in the art will appreciate that the special purpose registers can be configured using various programming means (e.g., soft coded, hardwired, or the like) and the programming of these special purpose register can be implementation and processor architecture specific.

If helpers are to be used to resolve the register window boundary condition, IDU 130 determines (e.g., by interpreting special purpose registers or the like) to retrieve helpers and determines the type of register window boundary condition by detection logic 210. Detection logic 210 decodes the fetched instructions and identifies the register window boundary condition, if any, and forwards the information to a helper vector generator 220. Detection logic 210 also maintains all of the special purpose registers mentioned above. Helper vector generator 220 generates appropriate vectors for helpers and forwards the vectors to a helper storage 230. Helper storage 230 stores sets of helper instructions for ‘n’ register window boundary conditions, set(1)-(n) to handle specific register window boundary conditions. Each condition may require one or more helper instructions to resolve the condition.

Helper vector generator 220 can be configured to continuously generate vectors to retrieve helpers for a given condition until all the corresponding helpers are fetched from helper storage 230. Helper storage 230 can be configured according to the processor fetch width. For example, if the processor is configured to fetch three instructions in each cycle, helper storage 230 can be configured to provide three helpers in each access cycle. Thus, a set of helpers can be organized as one or more groups of instructions. Helper vector generator 220 also receives controls from an instruction decode unit in the processor. The instruction decode unit can control helper vector generator 220 to generate appropriate vectors for a given condition and to control the vector generation in case of resource stall conditions when the helpers cannot be processed until the resource stall condition is resolved.

For purposes of illustration, in the present example, one helper storage is shown for ‘n’ conditions. However one skilled in the art will appreciate that individual helper storage can be configured for each condition or helper storage can be configured to store a combination of various helpers for efficiency purposes. Similarly, detection logic 210 can be configured to provide hardwired vectors for the starting address of each set of helpers and consecutive vectors can be generated by shifting the vector (e.g., shift left, shift right or the like) in helper vector generator 220.

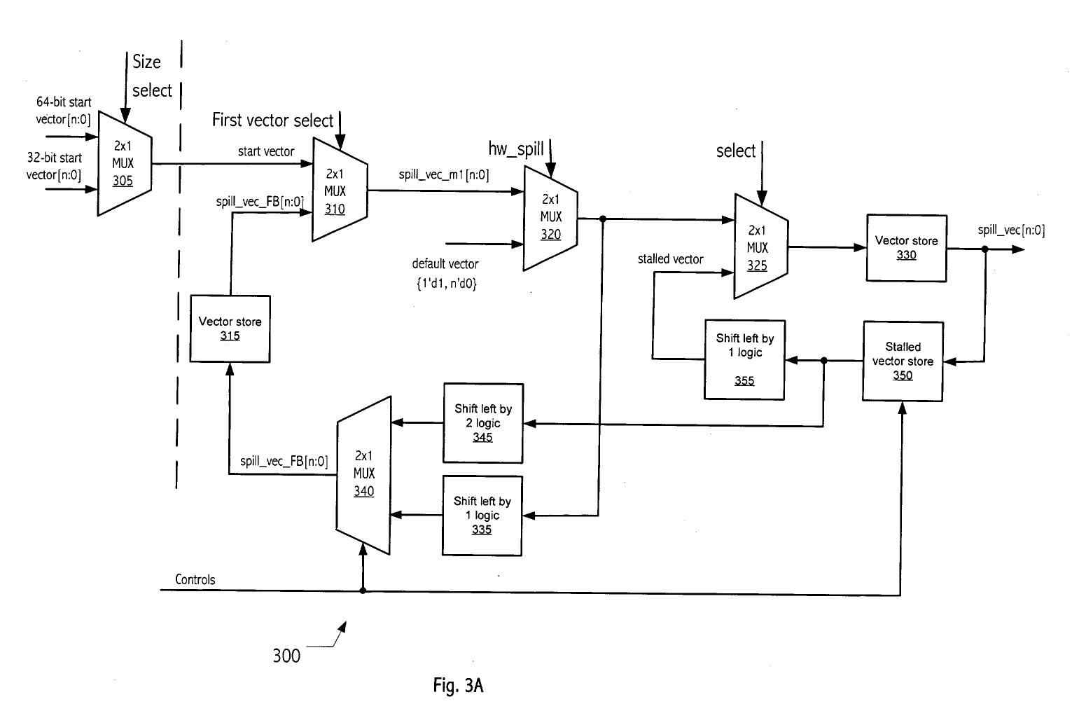

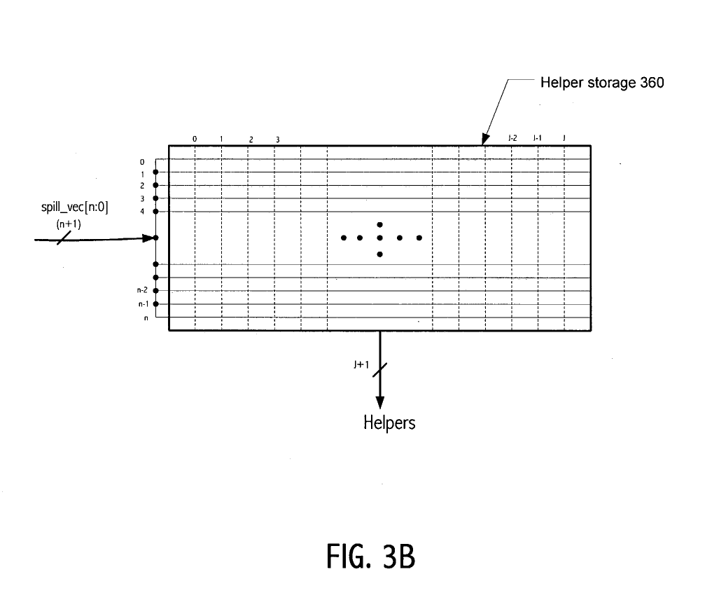

FIG. 3A illustrates an implementation of a register window boundary handler system 300 using helpers for a given condition according to an embodiment of the present invention. For purposes of illustration, specific bit sizes are used. However, one skilled in the art will appreciate that any bit size can be used for each element of the register window boundary handler system 300. Further, window-spill condition is used in the present example. However, system 300 can be used for any trap condition.

System 300 includes a 2×1 multiplexer MUX 305. MUX 305 selects between two input vector start addresses. A ‘n-bit’ 64-bit start vector [n:0] represents the first address in a helper storage where the 64-bit helpers are stored and ‘n-bit’ 32-bit start vector [n:0] represents the first address in the helper storage where the 32-bit helpers are stored. In the present example, the helper size (e.g., 32 or 64) in the helper storage is according to the configuration of the processor and the code being executed in the processor. However, helpers can be configured to be of any size according to the processor architecture. The size of the start vector represents the configuration size of the helper storage. In the present example, the helper storage includes ‘n+1’ word lines (fetch groups) thus the start vector is configured to provide ‘n+1 bit’ vector to access corresponding helper fetch groups in the helper storage. The selection of 32 or 64 bit helpers can be made by one of the special purpose registers initialized by the software (operating system or the like) to select the appropriate size. In the current embodiment of the present invention, bit ‘n’ of the special purpose register, for example, located in detection logic 210, initialized by software (operating system or the like) is used to select 32 or 64 bit helpers for the current condition size. For example, if the bit is set to logic one, then detection logic 210 provides size select control signal to MUX 305 to select 64-bit start vector and vice versa. The start vectors can be either hardwired or programmable. For purposes of illustration, in the present example, the size and the value of start vectors are hardwired according to the configuration of the helper storage. However, one skilled in the art will appreciate that the start vectors can be programmed using known techniques if the helper storage is configured to be programmable.

The selected start vector is forwarded to a 2×1 multiplexer MUX 310. Upon receiving a select control from the IDU, MUX 310 selects between the start vector and next vector, spill_vec_FB[n:0]. The next vector (as explained later) is received from a vector store 315. During the first cycle of window-spill processing, the IDU initially provides the select for first vector select to MUX 310 to select start vector and after the first group of helpers is fetched, the IDU continues to select the next vector from MUX 310. The selected vector, spill_vec_m1[n:0] is forwarded to a 2×1 multiplexer MUX 320. MUX 320 selects between a default vector and spill_vec_ml [n:0]. The default vector is pre-programmed address of the helper storage. The default vector location in the helper storage can be programmed using any function (e.g., no-operation or the like). MUX 320 receives a control signal, hw_spill from the IDU to select the vector accordingly. When the IDU determines that the condition requires hardware handling then the IDU selects the vector spill_vec_m1 [n:0]. Otherwise in other cases (e.g., software trap or the like), the IDU selects the default vector so the condition can be processed by other means (e.g., software trap or the like).

MUX 320 forwards the selected vector to a 2×1 multiplexer MUX 325. MUX 325 selects between the selected vector and a stalled vector (described later). MUX 325 forwards the selected vector to a vector store 330. Vector store 330 stores the vector and presents the vector to the helper storage to retrieve corresponding helper group. In the present example, the addresses for the helper storage are generated using a shift-left technique. However the addresses can be generated using various other means (e.g., shift-right technique, using address generator, programmable logics, application specific integrated circuits or the like). In the present example, the output of MUX 320 is coupled to a shift-left-by-1 logic 335 (logic 335). Logic 335 shifts the selected vector by 1 position left to generate the next address for the helper storage. The left shifted vector is forwarded to a 2×1 multiplexer MUX 340. MUX 340 selects between vector forwarded by logic 335 and a shift-left-by-2 logic 345 (logic 345). Logic 345 generates a vector for stalled condition (described later herein). MUX 340 selects vector according to a select control signal from the IDU.

MUX 340 forwards the selected vector, spill_vec_FB [n:0] to vector store 315. During the next cycle, the IDU provides controls to MUX 310 to select vector spill_vec_FB [n:0] for the next trap helper group. For purposes of illustration, in the present example, the helper storage includes 14 helper groups for window-spill condition, i.e. six for 64 bit spill, 7 for 32 bit spill, and one default, and during the first cycle of window-spill processing, the first vector for the first location in the helper storage is {8′d0,000001} (assuming a 64 bit spill). The IDU selects the first vector at MUX 310 which is forwarded through MUX 320 and MUX 325 to vector store 330 and is presented to the helper storage. During the first cycle of 64 bit window-spill processing, logic 335 left sifts the first vector, {8′d0,000001} to generate the second vector {8′d0,000010}. Considering no resources stall, the second vector is selected by MUX 340 and is stored in vector store 315. During the second cycle of the processing, the IDU de-selects the first vector at MUX 310 and for the remaining cycles, continues to select the next vector at MUX 310 which in the present case is {8′d0,000010}. Similarly, under no resource stall condition, the remaining vectors {8′d0,000100}, {8′d0,001000}, {8′d0,010000}, and {8′d0,10000} are generated and used to retrieve corresponding helper groups from the helper storage.

One skilled in the art will appreciate that while a 14 bit vector is used for purposes of illustrations, the vector can be of any size according to the size of the helper storage. Further, the first vector can point to any location in the helper storage as selected by MUX 305 and defined by individual 32-bit and 64-bit start vector. Further, the number of different size vectors at MUX 305 can also be configured according to the architecture of the processor. For example, MUX 305 can be configured as N×1 MUX to select among vectors of N different sizes or an N×1 MUX can be configured using various different size multiplexers.

When the processor has resource constraints (e.g., not enough entries available in live instruction table (LIT), load queue (LQ), store queue (SQ) or the like) then the IDU cannot process helpers. In such cases, the IDU saves the last vector generated before the resource stall in a vector store 350 using resource stall controls and a shift-left-by-1 logic 355 (“logic 355”) left sifts the vector to generate next vector. The resource stall control signal is also used by the IDU to select the output of logic 355 at MUX 325. Thus, when the resource stall condition is established two vectors are generated. For example, in the previous illustration, if the current vector is {8′d0,000010} in the second cycle then the helpers corresponding to the vector {8′d0,000010} will be accessed and processed in the decode pipeline. However, when a resource stall condition is detected while processing the helper vector {8′d0,000010}in the decode pipeline, the IDU latches the vector {8′d0,000010} in vector store 350 and logic 355 left shifts the vector to generate the next vector {8′d0,000100}. The resource stall control signal causes MUX 325 to select vector {8′d0,000100} and the helpers corresponding to vector {8′d0,000100}are retrieved from the helper storage and forwarded to the decode pipeline. However, the helpers corresponding to vector {8′d0,000100}are not forwarded beyond decode stage due to the resource stall condition.

During the stall condition, the last vector {8′d0,0000101} is forwarded to a shift-left-by-2 logic 345 (“logic 345”). Logic 345 left shifts the last vector {8′d0,000010} by two and generates the vector {8′d0,00100}. The resource stall condition causes MUX 340 to select the output of logic 345, vector {8′d0,001000}, and forward it as spill_vec_FB [n:0]. Eventually, vector {8′d0,0010001} is presented to MUX 325 however the vector is not selected by MUX 325 due to the resource stall condition. When the resource stall condition is resolved by the processor, the resource stall control is removed by the IDU and system 300 resumes normal operation. When the resource stall control signal is removed, MUX 325 selects vector {8′d0,001000} and forwards it to the helper storage via vector store 330. Thus, the first vector after the resource stall is the next vector in line to retrieve the helpers. One skilled in the art will appreciate that by using logic 345, one processing cycle is saved. However, system 300 can be configured to begin processing at any vector address (e.g., using additional processing cycles or the like).

FIG. 3B illustrates an example of a helper storage 360 according to an embodiment of the present invention. Helper storage 360 is configured as (n+1)×(J+1) storage including ‘n+1’ words where each word is ‘J+1’ bits long. The number of bits in each word can be configured to represent a number of simple instructions. For example, in a three instruction processor that fetches three instructions in each cycle, J+1 bits can be configured to represent three instructions (helpers) plus additional control bits if needed. Helper storage 360 receives word line control from a vector, spill_vec [n:0] (e.g., output of vector store 330 or the like). The vector selects appropriate word line and the helpers corresponding to the vectors are retrieved from helper storage 360. The helpers for each processing can vary according to the function. However, if the processor is configured to retrieve a certain number of instructions in one cycle (e.g., three in the present case) then each vector address will retrieve that many helpers from the helper storage. For a function that requires less helpers than can be fetched in one cycle, the helper storage must be configured to address it. One way to resolve that is to add no operation (NOP) instructions in the ‘empty slots’ of a fetch group. For example, if a function requires seventeen helpers in a processor with a fetch group of three instructions per cycle then the function requires at least six cycles to retrieve helpers from the helper storage because the helper storage is configured to provide three helpers in each cycle. The five cycles will retrieve fifteen helpers from the helper storage and the sixth cycle will also retrieve three helpers from the helper storage. However, the function only requires two more helper thus the remaining one helper can be programmed as NOP or similar or other functions (e.g., administrative instruction, performance measurement instruction or the like).

Retrieving the same number of helpers from the helper storage as the number of instructions that can be fetched in one cycle simplifies the logic design for vector generation. Every time a vector is presented as the word address to the helper storage, the helper storage provides all the helpers corresponding to the vector including the ‘slot fillers’ (e.g., NOP, administrative, performance related instructions or the like). Retrieving the same number of helpers corresponding to a fetch group improves the speed of address interpretation. The configuration of helper storage 360 depends upon the configuration of instruction opcodes in the processor. The bits in helper storage 360 can be configured to include hardwired bits according to the configuration of instruction opcodes so that appropriate helpers can be retrieved from helper storage 360 for a given function.

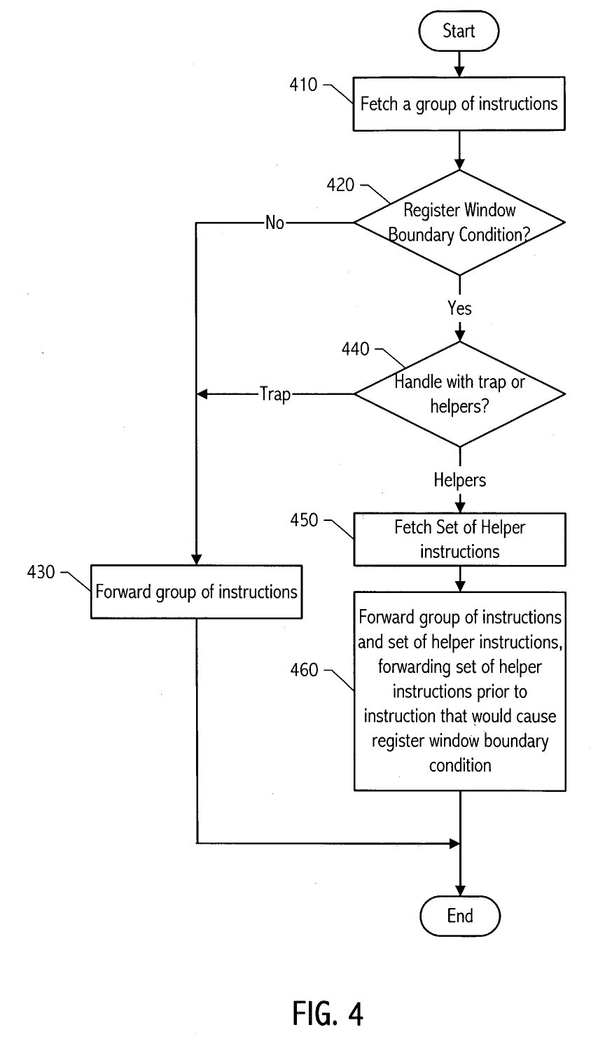

FIG. 4 illustrates a flow diagram of handling a register window boundary condition according to an embodiment of the present invention. A group of instructions is fetched, step 410. The group of instructions is evaluated to determine if one or more of the instructions will cause a register window boundary condition, step 420. This determination is made, for example, by determining if the instruction is a register window manipulation instruction such as a SAVE, RESTORE or RETURN (Sparc v9) instruction, and consulting register window management registers and control registers to determine if the register window manipulation instruction will result in a register window boundary condition if executed, necessitating, for example, a register window spill or fill.

If a register window boundary condition will not be caused, the group of instructions is forwarded for execution, step 430. If a register window boundary condition will be caused, a determination is made whether to handle the register window boundary condition in software with a trap or in hardware with helpers, step 440. If the register window boundary condition will be handled with a trap, the group of instructions is forwarded for execution, step 430. Note that when executed, a trap will be generated and a trap handler will be called. Also note that the condition is reported in an exception report to the commit unit which is responsible for calling the software to handle the trap.

If the register window boundary condition will be handled with helpers, a set of helper instructions are fetched from a helper store, step 450. Next the group of instructions and the set of helpers are forwarded for execution, where the set of helpers are forwarded prior to the instruction that would result in the register window boundary condition, step 460. The helpers resolve the register window boundary condition such that a spill/fill trap does not occur when the group of instructions is executed.

Note that if multiple instructions in the group of instructions will result in a register window boundary condition, multiple sets of helpers can be inserted, each set prior to the corresponding instruction.

While for purposes of illustration, a register window boundary condition is resolved using helper instructions, one skilled in the art will appreciate that any type of condition that typically is handled by taking a trap can be resolved using helper instructions.

Spill and Fill Helpers

The helper instructions to perform spill and fill operations can be defined according to the architecture of the target processor. In some embodiments, the present invention defines a set of helpers for each spill or fill operation that require more than one helper instruction. Table 1 illustrates an example of spill and fill operations and the associated helper instructions for a given target processor. While for purposes of illustration, in the present example, each spill or fill operation is implemented with various numbers of helper instructions. However, one skilled in the art will appreciate that the number of helpers for each operation can be defined according to the architecture of the target processor (e.g., the number of instructions that can be fetched in one processor cycle, number of simple instructions required to accomplish a given operation, flexibility of the processor architecture and the like).

| | Instruction format and helper | |
|---|---|---|
| Operation | Instructions generated | Helper definition |
| SPILL | 1. H_SRL %o6, 0, %temp | 1. Move the lower 32-bits of %o6 into |
| (spill current | 2. H_STW %10, [%temp +BIAS32 + 0] | lower 32-bits of %temp and clear upper |
| window into | 3. H_STW %11, [%temp +BIAS32 + 4] | 32-bits of %temp |
| primary address | 4. H_STW %12, [%temp +BIAS32 + 8] | 2-17. Spill the locals and ins of CWP+2 |
| space for 32-bit | 5. H_STW %13, [%temp +BIAS32 + 12] | onto the stack |
| code) | 6. H_STW %14, [%temp +BIAS32 + 16] | 18. Clear the upper 32-bits of %o6 |
| | 7. H_STW %15, [%temp +BIAS32 + 20] | 19. Update %cansave and %canrestore |
| | 8. H_STW %16, [%temp +BIAS32 + 24] | (make sure the instruction following |
| | 9. H_STW %17, [%temp +BIAS32 + 28] | H_SAVED sees the following value in |
| | 10. H_STW %i0, [%temp +BIAS32 + 32] | CWP −> (SCWP = SCWP-2) |
| | 11. H_STW %i1, [%temp +BIAS32 + 36] | |
| | 12. H_STW %i2, [%temp +BIAS32 + 40] | |
| | 13. H_STW %i3, [%temp +BIAS32 + 44] | |
| | 14. H_STW %i4, [%temp +BIAS32 + 48] | |
| | 15. H_STW %i5, [%temp +BIAS32 + 52] | |
| | 16. H_STW %i6, [%temp +BIAS32 + 56] | |
| | 17. H_STW %i7, [%temp +BIAS32 + 60] | |
| | 18. H_SRL %o6, 0, %o6 | |
| | 19. H_SAVED | |
| SPILL | 1. H_STX %10, [%o6+BIAS64 + 0] | 1-16. Spill the locals and ins of CWP+2 |
| (spill current | 2. H_STX %11, [%o6+BIAS64 + 8] | onto the stack |
| window into | 3. H_STX %12, [%o6+BIAS64 + 16] | 17. Update %cansave and %canrestore |
| primary address | 4. H_STX %13, [%o6+BIAS64 + 24] | (make sure the instruction following |
| space for 64-bit | 5. H_STX %14, [%o6+BIAS64 + 32] | H_SAVED sees the following value in |
| code) | 6. H_STX %15, [%o6+BIAS64 + 40] | CWP −> (SCWP = SCWP-2) |
| | 7. H_STX %16, [%o6+BIAS64 + 48] | |
| | 8. H_STX %17, [%o6+BIAS64 + 56] | |
| | 9. H_STX %i0, [%o6+BIAS64 + 64] | |
| | 10. H_STX %i1, [%o6+BIAS64 + 72] | |
| | 11. H_STX %i2, [%o6+BIAS64 + 80] | |
| | 12. H_STX %i3, [%o6+BIAS64 + 88] | |
| | 13. H_STX %i4, [%o6+BIAS64 + 96] | |
| | 14. H_STX %i5, [%o6+BIAS64 + 104] | |
| | 15. H_STX %i6, [%o6+BIAS64 + 112] | |
| | 16. H_STX %i7, [%o6+BIAS64 + 120] | |
| | 17. H_SAVED | |
| FILL | 1. H_SRL %o6, 0, %temp | 1. Move the lower 32-bits of %o6 into |
| (fill data from | 2. H_LDUW [%temp +BIAS32+0], %10 | lower 32-bits of %temp and clear the |
| primary address | 3. H_LDUW [%temp +BIAS32+4], %11 | upper 32-bits of %temp |
| space into current | 4. H_LDUW [%temp +BIAS32+8], %12 | 2-17. Fill the locals and ins of CWP-1 |
| window for 32- | 5. H_LDUW [%temp +BIAS32+12], %13 | from the stack |
| bit code) | 6. H_LDUW [%temp +BIAS32+16], %14 | 18. Clear the upper 32-bits of %o6 |
| | 7. H_LDUW [%temp +BIAS32+20], %15 | 19. Update %cansave and %canrestore |
| | 8. H_LDUW [%temp +BIAS32+24], %16 | |
| | 9. H_LDUW [%temp +BIAS32+28], %17 | |
| | 10. H_LDUW [%temp +BIAS32+32], %i0 | |
| | 11. H_LDUW [%temp +BIAS32+36], %i1 | |
| | 12. H_LDUW [%temp +BIAS32+40], %i2 | |
| | 13. H_LDUW [%temp +BIAS32+44], %i3 | |
| | 14. H_LDUW [%temp +BIAS32+48], %i4 | |
| | 15. H_LDUW [%temp +BIAS32+52], %i5 | |
| | 16. H_LDUW [%temp +BIAS32+56], %i6 | |
| | 17. H_LDUW [%temp +BIAS32+60], %i7 | |
| | 18. H_SRL %o6, 0, %o6 | |
| | 19. H_RESTORED | |
| FILL | 1. H_LDX [%o6+BIAS64+0], %10 | 1-16. Fill the locals and ins of CWP-1 |
| (fill data from | 2. H_LDX [%o6+BIAS64+8], %11 | from the stack |
| primary address | 3. H_LDX [%o6+BIAS64+16], %12 | 17. Update %cansave and %canrestore |
| space into current | 4. H_LDX [%o6+BIAS64+24], %13 | |
| window for 64- | 5. H_LDX [%o6+BIAS64+32], %14 | |
| bit code) | 6. H_LDX [%o6+BIAS64+40], %15 | |
| | 7. H_LDX [%o6+BIAS64+48], %16 | |
| | 8. H_LDX [%o6+BIAS64+56], %17 | |
| | 9. H_LDX [%o6+BIAS64+64], %i0 | |
| | 10. H_LDX [%o6+BIAS64+72], %i1 | |
| | 11. H_LDX [%o6+BIAS64+80], %i2 | |
| | 12. H_LDX [%o6+BIAS64+88], %i3 | |
| | 13. H_LDX [%o6+BIAS64+96], %i4 | |
| | 14. H_LDX [%o6+BIAS64+104], %i5 | |
| | 15. H_LDX [%o6+BIAS64+112], %i6 | |
| | 16. H_LDX [%o6+BIAS64+120], %i7 | |
| | 17. H_RESTORED | |

The above description is intended to describe at least one embodiment of the invention. The above description is not intended to define the scope of the invention. Rather, the scope of the invention is defined in the claims below. Thus, other embodiments of the invention include other variations, modifications, additions, and/or improvements to the above description.

It is to be understood that the architectures depicted herein are merely exemplary, and that in fact many other architectures can be implemented which achieve the same functionality. In an abstract, but still definite sense, any arrangement of components to achieve the same functionality is effectively coupled such that the desired functionality is achieved. Hence, any two components herein combined to achieve a particular functionality can be seen as coupled to each other such that the desired functionality is achieved, irrespective of architectures or intermedial components. Likewise, any two components so associated can also be viewed as being operably coupled to each other to achieve the desired functionality.

While particular embodiments of the present invention have been shown and described, it will be clear to those skilled in the art that, based upon the teachings herein, various modifications, alternative constructions, and equivalents may be used without departing from the invention claimed herein. Consequently, the appended claims encompass within their scope all such changes, modifications, etc. as are within the spirit and scope of the invention. Furthermore, it is to be understood that the invention is solely defined by the appended claims. The above description is not intended to present an exhaustive list of embodiments of the invention. Unless expressly stated otherwise, each example presented herein is a nonlimiting or nonexclusive example, whether or not the terms nonlimiting, nonexclusive or similar terms are contemporaneously expressed with each example. Although an attempt has been made to outline some exemplary embodiments and exemplary variations thereto, other embodiments and/or variations are within the scope of the invention as defined in the claims below.

What is claimed is:

1. A method of operating a processor, the method comprising:
fetching a plurality of instructions;
detecting that one of the fetched instructions will, when executed, result in a register window boundary condition; and
forwarding a set of helper instructions prior to forwarding the detected instruction to avoid the register window boundary condition when the one of the detected of instruction is executed.

2. The method of claim 1, further comprising:
determining whether to resolve the register window boundary condition with the set of helper instructions or by generating a trap and calling a trap handler routine.

3. The method of claim 1, wherein the detecting comprises:
identifying a register window manipulation instruction in the plurality of instructions; and
determining a state of window management registers to determine if the register window manipulation instruction will, when executed, result in a register window boundary condition.

4. The method of claim 3, wherein the register manipulation instruction is one of a save instruction, a return instruction, and a restore instruction.

5. The method of claim 1, wherein the register window boundary condition is a register window underflow condition requiring one or more register windows to be filled.

6. The method of claim 1, wherein the register window boundary condition is a register window overflow condition requiring one or more register windows to be spilled.

7. The method of claim 1, wherein the set of helper instructions is organized as one or more groups of helper instructions and wherein a register identifies an address in a helper store of an initial group of the one or more groups, the register corresponding to the register window boundary condition.

8. The method of claim 1, wherein the set of helper instructions is organized as one or more groups of instructions, each of the one or more groups having three instructions.

9. The method of claim 1, wherein the set of helper instructions is organized as one or more groups of instructions, each of the one or more groups having N helper instructions, wherein N is a number of instructions that can be fetched in one cycle by the processor.

10. A processor comprising:
instruction fetch logic configured to fetch a plurality of instructions;
boundary condition logic configured to detect that one of the fetched instructions will, when executed, result in a register window boundary condition; and
helper logic configured to forward a set of helper instructions prior to forwarding a detected instruction to avoid the register window boundary condition from occurring when the detected instruction is executed.

11. The processor of 10, further comprising:
a register that identifies whether to resolve the register window boundary condition with the set of helper instructions or by generating a trap and calling a trap handler routine.

12. The processor of 10, wherein the boundary condition logic comprises:
logic to identify a register window manipulation instruction in the plurality of instructions; and
logic to compare a state of window management registers to determine if the register window manipulation instruction will, when executed, result in a register window boundary condition.

13. The processor of 12, wherein the register manipulation instruction is one of a save instruction, a restore instruction, and a return instruction.

14. The processor of 10, wherein the register window boundary condition is a register window underflow condition requiring one or more register windows to be filled.

15. The processor of 10, wherein the register window boundary condition is a register window overflow condition requiring one or more register windows to be spilled.

16. The processor of 10, wherein the set of helper instructions is organized as one or more groups of instructions, the processor further comprising a register that identifies an address in a helper store of an initial one of the one or more groups, the register corresponding to the register window boundary condition.

17. The processor of 10, wherein the set of helper instructions is organized as one or more groups of instructions, each of the one or more groups having three instructions.

18. The processor of 10, wherein the set of helper instructions is organized as one or more groups of instructions, each of the one or more groups having N helper instructions, wherein N is a number of instructions that can be fetched in one cycle by the processor.

19. A processor that detects a fetched instruction that will, when executed, cause a register window boundary condition and avoids the register window boundary condition by forwarding for execution a set of helper instructions prior to forwarding for execution the fetched instruction.

20. A processor that detects a fetched instruction that will, when executed, cause a trap condition and avoids the trap condition by forwarding a set of helper instructions prior to forwarding the fetched instruction.

21. An apparatus comprising:
means for fetching a plurality of instructions;
means for detecting that one of the fetched instructions will, when executed, result in a register window boundary condition; and
means for forwarding a set of helper instructions prior to forwarding a detected instruction to avoid the register window boundary condition when the one of the detected of instruction is executed.

22. The apparatus of claim 21, further comprising:
means for determining whether to resolve the register window boundary condition with the set of helper instructions or by generating a trap and calling a trap handler routine.

23. The apparatus of claim 21, wherein the means for detecting comprises:
means for identifying a register window manipulation instruction in the plurality of instructions; and
means for determining a state of window management registers to determine if the register window manipulation instruction will, when executed, result in a register window boundary condition.

24. The apparatus of claim 23, wherein the register manipulation instruction is one of a save instruction, a return instruction, and a restore instruction.

25. The apparatus of claim 21, wherein the register window boundary condition is a register window underflow condition requiring one or more register windows to be filled.

26. The apparatus of claim 21, wherein the register window boundary condition is a register window overflow condition requiring one or more register windows to be spilled.

27. The apparatus of claim 21, wherein the set of helper instructions is organized as one or more groups of helper instructions and wherein a register identifies an address in a helper store of an initial group of the one or more groups, the register corresponding to the register window boundary condition.

28. The apparatus of claim 21, wherein the set of helper instructions is organized as one or more groups of instructions, each of the one or more groups having three instructions.

29. The apparatus of claim 21, wherein the set of helper instructions is organized as one or more groups of instructions, each of the one or more groups having N helper instructions, wherein N is a number of instructions that can be fetched in one cycle by the processor.
